(19) United States
(12) Patent Application Publication
(10) Pub. No.: US 2004/0033043 A1
(43) Pub. Date: Feb. 19, 2004

(54) Dispersion tailoring in optical fibres

(76) Inventors: Tanya Mary Monro, Hampshire (GB); David John Richardson, Hampshire (GB)

Correspondence Address: Don W Bulson, Renner Otto Boisselle & Sklar, 19th Floor, 1621 Euclid Avenue, Cleveland, OH, 44115, US

(21) Appl. No.: 10/415,688

(22) PCT Filed: Nov. 9, 2001
(86) PCT No.: PCT/GB01/04987

(30) Foreign Application Priority Data
Nov. 9, 2000 (GB) 0027399.5

(51) Int. Cl. G02B 6/20; C03B 37/022

(52) U.S. Cl. 385/125; 65/393

(57) ABSTRACT

An optical fibre is provided with dispersion tuning holes (510) arranged in the wings of the modal field distribution (512). These dispersion tuning holes can be used in a holey or conventional fibre geometry to tune the fibre dispersion independently from the other modal properties, such as the mode shape, to generate birefringence and for other dispersion tuning applications. These holes contrast from the usual “holey fibre” holes in that they are generally carefully placed laterally offset from the geometrical axis of the optical fibre by a distance of the same order as the mode field radius. The placement and size of the proposed “dispersion tuning holes” ensures that they affect the dispersion of the mode in a desired manner.

### BACKGROUND OF THE INVENTION

The invention relates to optical fibres, both holey fibres and conventional (unholey) fibres.

A conventional optical fibre comprises a core and a cladding, both of which are solid, usually glassy materials. The core is made to have a higher refractive index than the cladding so as to provide waveguiding. The most common optical fibre is silica-based with both the core and cladding being made of silica or a related compound such as a germano silicate or phosphosilicate compound, but with the core doped to increase its refractive index. While hugely successful, conventional optical fibres are limited in that their optical properties depend on the bulk properties of the core and cladding materials. This limits the scope for altering the optical properties of the fibre.

A holey fibre is an optical fibre whose optical confinement mechanism and properties are defined by an array of air holes that run down the entire fibre length. Light is guided in a holey fibre due to average index effects. If there is periodicity in the air holes perpendicular to the geometrical axis of the fibre additional photonic band gap effects may produce further effects. Previous work shows that holey fibres can possess a range of interesting characteristics, including unique dispersion properties such as dispersion flattening and anomalous dispersion below 1.3 μm [1], as well as single mode operation over an extended range of operating wavelengths [2]. Importantly, holey fibres lift some of the design constraints of conventional optical fibre. For example, the core and cladding materials can be the same, thus automatically eliminating the possibility of incompatibility between the core and cladding materials, for example arising from differential thermal contraction during fibre fabrication.

However, for both conventional fibres and previously proposed holey fibres, the modal properties of optical fibres such as the mode field diameter (MFD), mode shape, dispersion, etc, are typically closely linked. This imposes design limitations in known types of optical fibres, as it is not in general possible to decouple these properties, and hence they can not be independently specified.

### SUMMARY OF THE INVENTION

According to a first aspect of the invention there is provided an optical fibre comprising a core and a cladding suitable for guiding light of a predetermined wavelength, further comprising one or more dispersion tuning holes each arranged laterally displaced from the geometrical axis of the optical fibre, by a distance of at least one half the core radius.

According to a second aspect of the invention there is provided an optical fibre comprising a core and a cladding, comprising one or more holes arranged laterally displaced from the geometrical axis of the optical fibre and arranged with a two-fold or lower degree of rotational symmetry about the geometrical axis of the optical fibre to generate birefringence. The core and cladding are solid except for the one or more holes for generating birefringence. In other words, additional dispersion tuning holes for inducing birefringence can be added to an otherwise conventional fibre to induce birefringence. Moreover, such additional holes can be introduced to an otherwise normal holey fibre with solid (or hollow) core and holey cladding.

According to a third aspect of the invention there is provided an optical fibre comprising a core and a cladding defining a mode field area for light of a predetermined wavelength to be guided by the optical fibre, the optical fibre further comprising at least three holes arranged laterally displaced from the geometrical axis of the optical fibre and arranged rotationally symmetrically about the geometrical axis of the optical fibre to allow tuning of the dispersion of the optical fibre without generating birefringence, wherein the core and cladding are solid over the mode field area except for the at least three holes for tuning the dispersion.

Provision of such additional dispersion tuning holes in the above-stated aspects of the invention, can be used in a holey or conventional fibre geometry: to tune the fibre dispersion independently from the other modal properties such as the mode shape, the mode field diameter and the effective mode area; to generate birefringence; and for other dispersion tuning applications. These holes contrast from the usual “holey fibre” holes used for refractive index tuning in that they are generally carefully placed laterally offset from the geometrical axis of the optical fibre by a distance of the same order as the mode field radius. The placement and size of the proposed “dispersion tuning holes” ensures that they affect the dispersion of the mode in a desired manner.

In an embodiment, the dispersion tuning holes have a cross-sectional width of less than approximately one-tenth or one-sixth of the predetermined wavelength, so as to allow tuning of the dispersion of the optical fibre while limiting changes in mode size.

The cladding may be solid as in conventional fibre, or holey, being made up of refractive index tuning holes having cross-sectional widths greater than those of the dispersion tuning holes mentioned above. In any case the core radius is defined by the core/cladding interface defined by a refractive index change. This can either be a result of core and cladding being made of materials with different refractive indices, as in a conventional fibre, or be as a result of the cladding having a lower average refractive index by virtue of being holey.

In one group of embodiments, the dispersion tuning holes are located interstitially with respect to a lattice defined by the preform rods used to make the optical fibre. In the case that there is a holey outer cladding, the dispersion tuning holes are thus located interstitially with respect to a lattice formed by the refractive index tuning holes and the core. However, the cladding may be solid in which case the lattice can be defined most conveniently by referring back to the preform structure.

In another group of embodiments, the dispersion tuning holes are located substitutionally with respect to a lattice defined by the preform rods used to make the optical fibre. In the case that there is a holey outer cladding, the dispersion tuning holes are thus located interstitially with respect to a lattice formed by the refractive index tuning holes and the core. However, the cladding may be solid in which case the lattice can be defined most conveniently by referring back to the preform structure.

The terms substitutional and interstitial will be understood from, for example, crystallography, e.g. from the use of these terms to describe point defects in crystals. In the case of the present invention, the “lattice” is defined by the axes of the rods of the preform used to make the optical fibre. Substitutionally positioned holes originate from axial holes in preform rods. Interstitially positioned holes originate from gaps formed between (solid or tubular) preform rods, these gaps having 3-fold symmetry, i.e. being essentially triangle-like in appearance.

The desired dispersion tuning holes or other dispersion tuning holes may also be provided in other ways. For example by drilling a solid preform, or a solid part of a preform.

In the embodiments described below, the dispersion tuning holes are laterally displaced from the geometrical axis of the optical fibre by between 0.5 to 2.5 times the core radius, although larger distances may be contemplated, for example up to 4.5 times the core radius. In the case of interstitial holes, if the preform is made of a hexagonally close packed array of rods, and the core is generated by a single preform rod, then the innermost interstitial holes will be laterally displaced from the geometrical axis of the fibre by between 0.5-1.5 times the core radius. In the case of substitutional holes, if the preform is made of a hexagonally close packed array of rods, the core is generated by a single preform rod, and the dispersion tuning holes are generated by holes in the innermost ring of preform rods, then the substitutional holes will be laterally displaced from the geometrical axis of the fibre by between 1-2 times the core radius. In another substitutional hole example, if the preform is made of a hexagonally close packed array of rods, the core is generated by seven preform rods (centre rod and six surrounding rods), and the dispersion tuning holes are generated by holes in the second ring of preform rods, then the substitutional holes will be laterally displaced from the geometrical axis of the fibre by between 3-4 times the radius corresponding to the radius of the drawn preform rod, which will be 1 to 4/3 times the core radius, since the core is defined by seven preform rods, not one, i.e. the core radius is 3 times the drawn preform rod radius.

The dispersion tuning effect of the dispersion tuning holes allows a conventional silica transmission fibre which has slightly positive group velocity dispersion of around +17 ps/nm/km at 1.55 μm, to be “tuned” to become effectively dispersionless. More particularly, the dispersion tuning holes can be sized and arranged to provide the optical fibre with group velocity dispersion of between ±5 ps/nm/km, more preferably ±4 ps/nm/km, still more preferably ±2 ps/nm/km, or most preferably ±1 ps/nm/km.

If three or more of the dispersion tuning holes are rotationally symmetrically arranged around the geometrical axis of the fibre, dispersion tuning is achieved without inducing any birefringence of the mode. Accordingly, in embodiments of the invention, the one or more dispersion tuning holes comprises at least three holes arranged symmetrically about the geometrical axis of the optical fibre to allow tuning of the dispersion of the optical fibre without generating birefringence.

On the other hand if one or two dispersion tuning holes are provided, or higher number of dispersion tuning holes are provided with a non-equal angular distribution about the geometrical axis, then birefringence can be induced. Accordingly, in embodiments of the invention, the one or more dispersion tuning holes are arranged with a two-fold or lower degree of rotational symmetrically about the geometrical axis of the optical fibre to generate birefringence. The use of the tuning holes to provide birefringent fibre is potentially very attractive, since this provides a simple, flexible way of fabricating birefringent fibre with a desired degree of birefringence.

Optical fibre according to the first aspect of the invention may be used as transmission fibre in a transmission system. Namely, according to a second aspect of the invention there is provided an optical fibre transmission system comprising a transmitter, a receiver and an interconnecting optical fibre link, wherein the link comprises optical fibre according to the first aspect of the invention.

The link may comprise substantially dispersionless optical fibre as described above. Alternatively, the link may overall be substantially dispersionless by being made up of alternate lengths of conventional fibre (with lightly positive dispersion) and fibre according to the first aspect of the invention (with negative dispersion) to compensate. The lengths may or may not be the same, depending on the degree of dispersion in the respective types of fibre.

In the case of substitutionally located tuning holes used to make an otherwise conventional fibre, the preform may comprise a plurality of rods packed together in an array, the rods comprising at least one centre core rod, surrounded by a plurality of tuning rods, at least one of which has an axial hole therein, surrounded in turn by at least one further layer of cladding rods which are solid.

In the case of substitutionally located tuning holes used to modify a “conventional” holey fibre, the preform may comprise an optical fibre preform comprising a plurality of rods packed together in an array, the rods comprising at least one centre core rod surrounded by a plurality of tuning rods, at least one of which has an axial hole therein, surrounded in turn by at least one further layer of cladding rods which have further axial holes therein, wherein the axial holes of the cladding rods are wider than the at least one axial hole of the tuning rods.

In embodiments of either preform, there is one centre core rod which is solid, and six tuning rods. However larger cores (e.g. made up of seven rods) may be used in which case there will be more tuning rods.

For making conventional fibres with dispersion tuning holes, an optical fibre preform may be provided that comprises a core rod of a core glass, a cladding tube of a cladding glass arranged outside the core rod, and a plurality of tuning rods, at least one of which has an axial hole therein, arranged between the cladding tube and the core rod.

An alternative for making conventional fibres with dispersion tuning holes is to use an optical fibre preform comprising a cladding tube of a cladding glass enclosing a core rod of a core glass, wherein the cladding tube and/or the core rod has at least one axial hole therein.

Another alternative for making conventional fibres with dispersion tuning holes is to use an optical fibre preform comprising a cladding tube of a cladding glass enclosing a powder of a core glass, wherein the cladding tube has at least one axial hole therein.

According to a further aspect of the invention, there is provided a method of fabricating an optical fibre, comprising:

providing an optical fibre preform as specified above; and

drawing the preform into an optical fibre in which the axial holes in the core rods are retained with a cross-sectional width of between 0.05 and 0.2 micrometers.

According to a still further aspect of the invention, there is provided a method of fabricating an optical fibre with interstitially located tuning holes, comprising:

providing an optical fibre preform comprising a plurality of rods packed together in an array, the rods comprising at least one solid centre rod surrounded by a plurality of outer rods, interstitial holes being formed between the centre and outer rods; and

drawing the preform into an optical fibre in which the interstitial holes are retained with a cross-sectional width of between 0.05 and 0.2 micrometers.

The outer rods may be tubular to form a holey outer cladding in the optical fibre, or solid to form a solid surround for the interstitial holes in the optical fibre.

In an embodiment, there is one solid centre rod and six outer rods adjacent to the centre rod, thereby to form six interstitial holes. However, larger numbers of centre rods (e.g. seven) may be used.

Finally, even in the holey fibre embodiments, in which the fibre has a holey cladding structure, it is contemplated that the core or a part of the core may be of different material from the cladding, for example doped in the manner of a conventional fibre to enhance the refractive index. However, more usually in the holey fibre embodiments, the core and cladding materials will be the same.

### BRIEF DESCRIPTION OF THE DRAWINGS

For a better understanding of the invention and to show how the same may be carried into effect reference is now made by way of example to the accompanying drawings.

FIG. 1 shows a schematic section view of a holey fibre with a large solid core. Beam profile contours of the fundamental guided mode at 1 μm are also shown.

FIG. 2 shows a schematic section view of a holey fibre with a solid core surrounded by a ring of six substitution holes. Beam profile contours of the fundamental guided mode at 1 μm are also shown.

FIG. 3A shows a schematic section view of a holey fibre. The solid core is surrounded by a ring of six interstitial holes.

FIG. 3B shows an expanded schematic section view of the core region of the holey fibre shown in FIG. 3A.

FIG. 4 shows a graph representing the group velocity dispersion, and mode field diameter of the fundamental mode at 1.5 μm in a holey fibre as a function of interstitial hole size.

FIG. 5 shows a schematic section view of a conventional step index fibre. Also shown are beam profile contours for the fundamental mode at 1.55 μm.

FIG. 6 shows a schematic section view of a step index fibre which additionally contains four longitudinal tuning holes. Also shown are beam profile contours for the fundamental mode at 1.55 μm.

FIG. 7 shows a schematic section view of a step index fibre which additionally contains one longitudinal tuning hole. Also shown are beam profile contours for the fundamental mode at 1.55 μm.

FIG. 8 shows a schematic section view of a step index fibre which additionally contains two longitudinal tuning holes. Also shown are beam profile contours for the fundamental mode at 1.55 μm.

FIG. 9 shows a schematic section view of a step index fibre which additionally contains two longitudinal tuning holes. Also shown are beam profile contours for the fundamental mode at 1.55 μm.

FIG. 10 shows a schematic section view of a step index fibre which additionally contains two longitudinal tuning holes. Also shown are beam profile contours for the fundamental mode at 1.55 μm.

FIG. 11 shows a number of fibres in schematic section view which contain different arrangements of longitudinal holes.

FIG. 12 shows a schematic perspective view of a preform for fabricating optical fibres according to an embodiment of the invention.

FIG. 13 shows a schematic perspective view of a furnace and drawing tower for drawing the preform stack shown in FIG. 13.

FIG. 14 shows a schematic perspective view of a preform for fabricating optical fibres according to another embodiment of the invention.

FIG. 15 shows a schematic perspective view of a further preform for fabricating optical fibres according to another embodiment of the invention.

FIG. 16 schematically shows a communication system which employs optical fibre according to an embodiment of the invention.

FIG. 17 schematically shows another communication system which employs optical fibre according to another embodiment of the invention.

### DETAILED DESCRIPTION

First Embodiment: Dispersion Tuning in Holey Optical Fibres

By taking advantage of the highly unusual cladding geometry in holey fibres, we have discovered a class of holey fibre profiles in which the dispersive properties can be adjusted independently from the other modal properties such as the mode shape, the mode field diameter and the effective mode area. This independence opens up new design possibilities, showing that holey fibres provide a flexible alternative to more conventional fibres when more than one of the modal properties has a tight design criterion.

The predictions made here are found using the efficient numerical model for holey fibres developed in [1, 3]. This method decomposes both the guided mode(s) of the fibre and the fibre core using localised functions, and uses a Fourier decomposition to describe the air holes which form the fibre cladding region. The accuracy of this method has been verified experimentally (see Refs [4, 5]), and it can accurately represent the types of holey fibre profile considered here. Note that as we are exploring dispersion design here, it is crucial to use a numerical model which can accurately describe the complex fibre profile, as previous work shows that the dispersion of a holey fibre is critically dependent on the specifics of the cladding geometry [6].

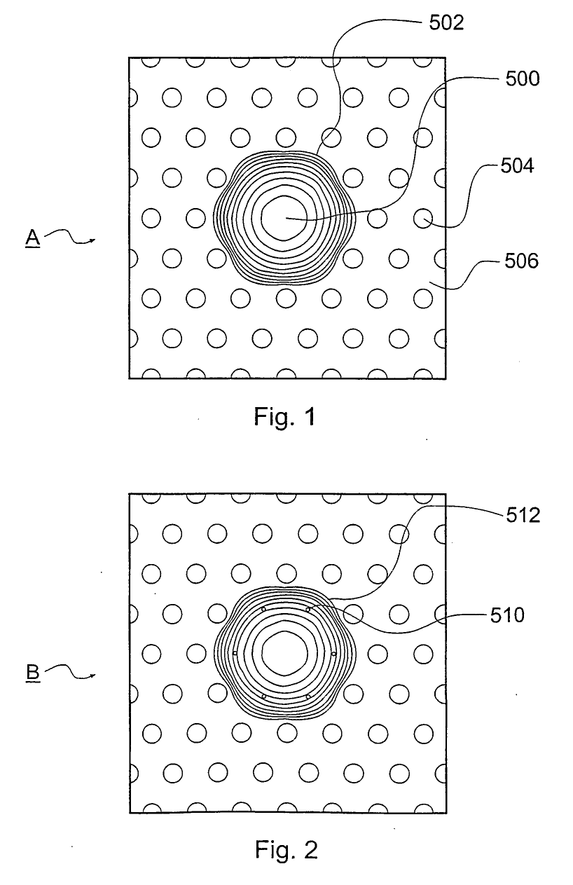

FIG. 1 shows a holey fibre in which the core 500 is formed by the removal of seven air holes 504 from the otherwise regular lattice (we label this fibre A). The fundamental mode 502 of this fibre is superimposed on the refractive index profile. Note that the mode decays rapidly when it encounters the large air holes 504 which form the cladding region 506. All holes 504 have diameter dₒᵤₜ=0.4 μm, and the hole 504 separation is Λ=1 μm. The fundamental mode at λ=1 μm is superimposed (contours 502 are separated by 1 dB). Fibre A is made of silica. Silica is also used in all the following specific examples. However, it will be understood that the teachings of the invention apply equally well to fibres made of any materials, for example glasses including silicate such as gemianosilicate and phosphosilicate fibres, as well as non-silicate glasses such as phosphide or sulphide glass fibres, for example gallium lanthanide sulphide, and also polymer materials.

In general, the dispersion of a fibre is much more sensitive to the details of the fibre design than, say, the mode size is, and here we make use of that to develop a new class of holey fibres in which small holes are used to tune the dispersion independent of the other fibre properties. By introducing these small tuning holes into the core of such a fibre, we show here that the fibres dispersive properties can be tuned.

FIG. 2 shows a holey fibre similar to that of FIG. 1, except an innermost ring of holes 510 of diameter dᵢₙ=0.1 μpm has been introduced (we label this fibre B). Fibre B demonstrates how effectively the dispersion can be isolated from the other optical properties in a holey fibre. In this structure, the inner ring of holes 510 of diameter dᵢₙ has been added, and these holes have been chosen to be small compared with the fundamental mode wavelength of 1 μm (dᵢₙ=0.1λ). Hence they cannot significantly influence the macroscopic modal properties such as the mode shape and size. This is clear in FIG. 2, which shows that the fundamental mode of this fibre 512 is virtually indistinguishable from the one in FIG. 1.

Table 1 gives the properties of the fundamental modes for the fibres shown in FIGS. 1 and 2. The inter-hole separation is Λ, dᵢₙ is the diameter of the innermost ring of holes, dₒᵤₜ is the diameter of all other holes, MFD is the mode field diameter, A_{eff} is the effective core area. The group velocity dispersion (GVD) of the waveguide is given, along with the net GVD, which includes material dispersion. This table shows that the addition of the inner ring of small holes in fibre B causes a change in the MFD of ≈0.07% and a change in the effective area of A_{eff}≈1.6%. Hence the coarse properties of the mode are effectively unchanged by the presence of the innermost ring of holes. However, note that the difference in the waveguide dispersion GVD_{wg} is ≈18%, and the difference in the net dispersion GVDₜₒₜ is ≈50%.

| | Λ | | | MFD | A_{eff} | GVD_{wg} | GVDₜₒₜ |
|---|---|---|---|---|---|---|---|
| | [μm] | dᵢₙ/Λ | dₒᵤₜ/Λ | [μm] | [μm²] | [ps/nm/km] | [ps/nm/km] |
| A | 1.0 | 0.0 | 0.4 | 2.721 | 6.04 | 30.5 | −9.3 |
| B | 1.0 | 0.1 | 0.4 | 2.723 | 5.95 | 25.8 | −14.0 |
| C | 1.0 | 0.05 | 0.4 | 2.732 | 6.09 | 29.9 | −9.9 |
| D | 1.0 | 0.05 | 0.4 | 2.743 | 6.14 | 29.9 | −9.9 |

We have considered a range of other fibre designs: as well as varying the size of the innermost holes dᵢₙ, the hole positions can also be varied. This flexibility in the fibre design freedom allows us to fine-tune the dispersion over at least the range shown in Table 1. Two examples are shown as fibres C and D in Table 1. Fibre C is the same structure as fibre B except that the holes in the innermost ring all have half the diameter of those in fibre B (i.e. dᵢₙ=0.05 μm). Fibre C is an intermediate profile which fits between fibres A and B, and so perhaps it is not surprising that its dispersion also takes an intermediate value and lies within the range of dispersion values set by fibres A and B. Note that by changing the diameter of the innermost holes from dᵢₙ=0.1→0.05 μm, the dispersion has been tuned by 2%, while the MFD has only been altered by 0.4%.

In fibre D, two of the holes in the inner ring have been removed, and the remaining four have been moved somewhat closer to the core of the fibre. In this fibre, the dispersion is the same as in fibre C, and instead the mode size (and also its shape) has been changed by altering the hole arrangement. Hence it is clear that some care needs to be taken in the choice of fibre profile, and that not all choices of inner hole arrangements will allow for dispersion tuning. We have explored the properties of a wide range of holey fibre profiles, and we note the following general trend: holes which are located in the wings of the modal field distribution allow the greatest degree of isolation of the fibre's dispersive properties from the other optical properties such as MFD or mode shape. In other words, holes located in the centre of the fibre/mode have less effect on the dispersion than holes placed somewhat outside the central core region, in the tails of the modal distribution.

Holey fibres are typically made by pulling a stack of glass capillaries into fibre form on a conventional fibre draw tower. When holey fibres with small air holes are made, higher temperatures are used than when large-hole holey fibres are made, and the spaces between the capillaries close up under surface tension. However, if the fibre is pulled at a cooler temperature, the holes do not close up as much, and so the interstitial holes between the capillaries are retained in the final fibre profile.

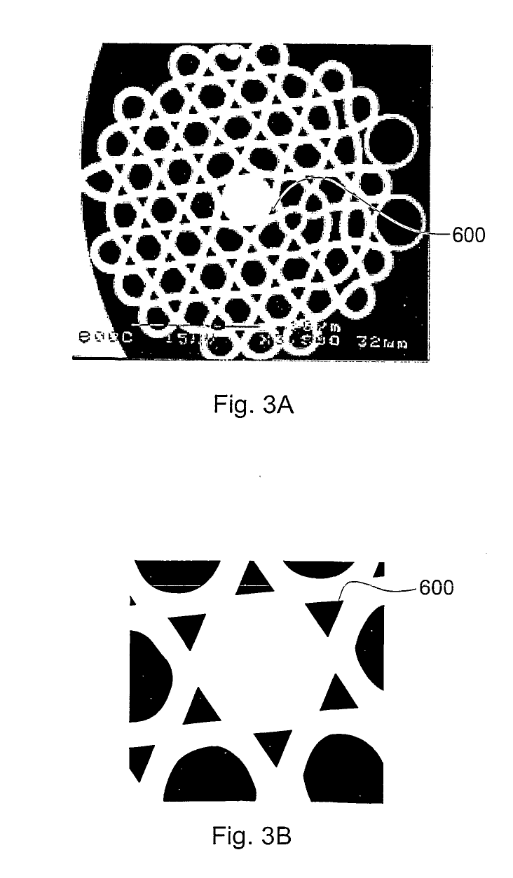

FIG. 3A shows an example of such a holey fibre, more especially FIG. 3A shows a scanning electron microscope image of a holey fibre with d/Λ=0.6, Λ=3.2 μm, interstitial holes are of diameter ≈0.27 μm.

FIG. 3B shows an expanded portion of the central region of the fibre shown in FIG. 3A.

This type of fibre possesses small holes 600 in the wings of the modal field, which as described above, allow for the possibility of tuning the dispersion independent from the mode size/shape. Using our full vector model for holey fibres [3], we have calculated the properties for the fibre in FIG. 3A both with and without interstitial holes, and we find that introducing interstitial holes of diameter 0.27 μm changes the mode area by 20% while changing the dispersion by 400% [at 1.5 μm]. This indeed suggests that the interstitial holes which are found in large air-fraction holey fibres can be used to tune the dispersion.

Here we explore the degree to which a holey fibre's dispersion can be tuned by adjusting the size of its interstitial holes. Consider a fibre with a hole pitch of 2 μm, and air holes of diameter 0.4 μm, arranged in the traditional hexagonal pattern. Note that as this fibre has relatively small air holes, it will be endlessly single-mode [8]. When no interstitial holes are present, this fibre has an MFD of 7.64 μm and a net GVD of 3.1 ps/nm/km (including both material and waveguide dispersion). All the values described here are calculated at 1.5 μm. We now describe how the GVD and MFD change when the size of the interstitial holes are tuned.

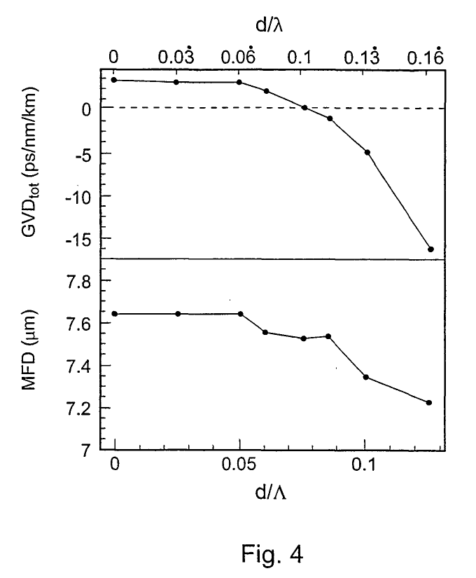

FIG. 4 is a graph showing the result of calculations for the MFD and net GVD at 1.5 μm as the size of the interstitial holes is tuned. The hole pitch in this fibre is 2 μm and the other holes (i.e. the non-interstitial holes) are 0.4 μm in diameter. The calculations assume circular section holes (hence reference to diameter). It will however be understood that interstitial holes will generally be three-cornered in shape, often generally triangular, if they are generated in hexagonal close packed rods in the preform. Similarly, for a square packed array of rods in the preform (encased by a square or rectangular jacket) the interstitial holes will generally be four-cornered in shape.

FIG. 4 shows that the dispersion can be tuned through the zero dispersion point simply by tuning the relative size of the interstitial holes. Note that this dispersion tuning is effectively isolated from the mode size, as in the earlier example. Here, the total tuning curve shown in FIG. 4 represents a six-fold change in the magnitude of the dispersion, accompanied by just a 6% change in MFD. This finding confirms that small holes placed in the wings of the mode field distribution can effectively isolate a fibre's dispersion properties from its other optical properties.

However, if the dispersion results from FIG. 4 are presented in terms of the waveguide dispersion (rather than the total dispersion, which includes material dispersion) then the 6% change in MFD corresponds to a dispersion tuning of approximately 60%. While this degree of dispersion tuning is likely to be useful in practise, it is not as well isolated from the mode size/shape variation as the examples given earlier. The principal reason for this is that this example was chosen to focus on a single mode fibre with a zero dispersion wavelength near 1.5 μm, which is a fibre type that has a wide variety of applications. We find that improved isolation is achieved when the hole pitch (Λ) is smaller, and when the holes which define the guidance are made larger, but such a fibre would not be a single mode fibre with a zero dispersion value near 1.5 μm.

In order to appreciate the improvement the holey fibres described above can offer for dispersion tuning compared with more conventional fibres, we here make a direct comparison with standard step index optical fibres. The calculations described here were made using a standard commercial software package for computing the modal properties of conventional fibre types. Consider a step index fibre with an NA of 0.175. We find that for a core diameter of 2.42 μm, the mode spot size is approximately 4.34 μm, and the waveguide dispersion is approximately −20 ps/nm/km at 1.5 μm. If this fibre profile is modified by changing the core diameter to 3.26 μm, then the resulting mode size and dispersion become 3.85 μm and −12 ps/nm/km respectively. Hence in these conventional fibres, a change in mode size of 13% is associated with a change in the waveguide dispersion of 67%. Hence the magnitude of the dispersion is altered by approximately five times the alteration in the mode size. Our calculations find that this ratio is typical in conventional fibre types.

We have demonstrated that it is possible to tune the dispersion in holey fibres with over two orders of magnitude less change in the mode size than conventional fibre types. This ability to tune the fibre dispersion independent from the mode size/shape could be extremely useful in practice.

From the calculations we have done so far, we can make some general conclusions as regards the types of holey fibre designs which are needed in order to isolate the dispersion from the other optical properties. Firstly, it is necessary for the tuning holes to be significantly smaller than the wavelength of the light used. As a rule of thumb, we find that these small holes need to have diameter dᵢₙ ≦0.1 λ in order for them to not significantly change the mode shape. Although holes this small have been produced in holey fibres, it can be difficult to reproducibly fabricate fibres with such small holes, as the effect of surface tension during the fabrication process tends to close up such small holes. Operating at longer wavelengths would allow the tuning holes to be more easily fabricated.

Secondly, we find that small holes located in the centre of the fibre/mode have less effect on the dispersion than small holes placed somewhat outside the central core region, in the tails of the modal distribution. Indeed, as shown above, by controlling the size of the interstitial holes which are often found in large air-fraction holey fibres, the dispersion can effectively be tuned. FIG. 4 shows an example in which the dispersion of a single mode holey fibre at 1.5 μm was tuned around the zero dispersion point.

Finally, we find that when the principle air holes in the holey fibre (i.e. the holes which define the cladding region) are large relative to the hole spacing, the dispersion tuning can be enhanced. In such fibres, the tails of the mode field diameters decay very rapidly when they encounter these large air holes. If small air holes are placed in this region where the field decays rapidly, the decoupling of the dispersion tuning from the other modal properties appears to be enhanced.

Note that the holey fibres described here all guide light due to the effective index difference between the core and the cladding, and that there is no requirement for the holes which form the cladding to be arranged periodically. Hence this mechanism for dispersion tuning is also directly applicable to non-periodic holey fibres. As an example, see Reference [6], which demonstrates the sensitivity of the waveguide dispersion to the locations of randomly distributed air holes in the cladding.

Second Embodiment: Dispersion Tuning in Conventional Optical Fibres

We propose that it should be possible to apply the concept presented here directly to more conventional fibres. Introducing dispersion tuning holes around the core of a conventional fibre should also open up the possibility of fine tuning the dispersive properties. However it is likely that extremely small air holes would need to be used, as the difference between the core and cladding refractive index in conventional fibres is typically much smaller than in holey fibres, and so holes of a fixed size would have a greater effect on the course properties of a conventional fibre. The choice of an appropriate hole size for a desired application is however quite complex, so there may be applications where larger holes are needed to produce dispersion tuning.

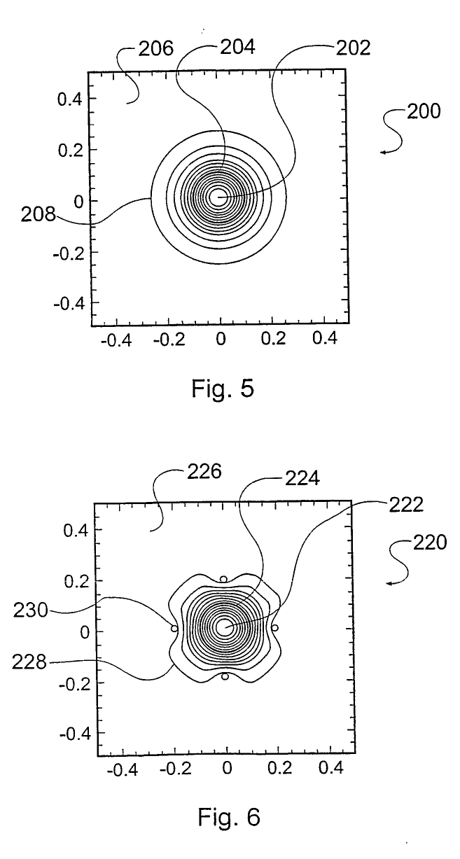

FIG. 5 shows in cross-section a schematic model of a conventional step-index optical fibre 200. The model fibre 200 comprises a core 202 of constant refractive index, a core boundary 204 and a cladding 206 of constant refractive index. The core 202 has a diameter of 8.2 μm, and the cladding 206 is considered to be of effectively infinite extent, at least insofar as its cross-section is significantly larger than the effective beam diameter of the considered transmitted mode. The model fibre 200 is constructed from a pure silica glass cladding and germanium (or other) doped silica glass core to provide a core refractive index of 1.4477, and a cladding refractive index of 1.444. Contours 208 which represent the fundamental guided mode of the fibre 200 at a wavelength of 1.55 μm are also shown in the figure. The waveguide dispersion of the model fibre 200 at this wavelength is calculated to be −6 ps/nm/km.

FIG. 6 shows in cross-section a schematic model of a novel step-index optical fibre structure 220. The model fibre 220 comprises a core 222, a core boundary 224 and a cladding 226, these features are similar to, and will be understood from, the corresponding features shown in FIG. 5. However, in addition the fibre 220 contains a plurality of holes 230 which run parallel to the guiding axis of the fibre 220. These holes 230 can, for example, be introduced into the fibre 220 prior to drawing. By providing suitable holes in a fibre pre-form, such as by drilling, the fibre 220 can be drawn in an otherwise conventional manner. Depending on the details of the exact drawing process, the materials, and the size of the final holes required, special steps may be taken to prevent the holes collapsing under surface tension during drawing. This can be achieved, for example, by drawing at a slightly lower temperature than for a conventional fibre, or by sealing the ends of the holes in the pre-form to ensure internal pressure is maintained throughout drawing to assist in preserving the holes against collapse. In the exemplary fibre 220, there are four longitudinal holes 230. These holes 230 are symmetrically arranged with equal angular spacing around the geometrical axis of the fibre, and equal distances from the geometrical axis. The holes 230 each have a diameter of 1 μm and their centres are 8.2 μm from the central axis of the fibre 220. Contours 228 which represent the fundamental guided mode of the fibre 220 at a wavelength of 1.55 μm are also shown in FIG. 6.

A comparison of the contours 228 shown in FIG. 6 and the contours 208 shown in FIG. 5 indicates that the central portion of the beam profile is largely unaffected by the introduction of the holes 230. There is, however, a significant level of distortion to the contours representing the outer portion of the beam. However, these portions of the beam profile represent only the outer wings of the fundamental guided mode within which relatively little power is transported. As far as the majority of beam power is concerned, the overall mode characteristics are relatively unaffected by the introduction of the holes and its profile remains largely similar. However, the calculated waveguide dispersion of the fibre 220 is significantly different to that of the conventional fibre 200. The introduction of the holes 230 changes the calculated waveguide dispersion from −6 ps/nm/km to −1.7 ps/nm/km. This is achieved without significantly changing the other modal properties of the beam.

By modifying different aspects of the introduced holes, such as their size, shape, placement, distribution and the number of them, the dispersive properties of the resulting fibre can be tuned. Accordingly, by modelling the propagation of the guided modes within fibres which comprise different arrangements of holes, fibres with parameters which most closely match those best suited to a particular application can be selected.

It is appreciated that that the dispersive properties of these types of fibres could be modified further by filling, or partially filling, the voids comprising the holes with materials with refractive indices different to that of air, for example. It is also appreciated that similar tunability could be achieved by similarly modifying additional examples of otherwise conventional fibres, such as, for example, graded-index fibres.

Third Embodiment: Birefringent Optical Fibre

By positioning dispersion tuning holes in an asymmetric fashion, or more accurately with two-fold or one-fold rotational symmetry about the centre axis of the fibre, it should be possible to tailor the birefringence of holey or conventional fibres. In such a case, each orthogonal component of the fundamental mode will see different hole distributions, and hence in this way their modal properties can be made to differ. Previous work shows that the optical properties of holey fibres are typically very sensitive to the hole distribution of the cladding [9]. This implies that such a technique is likely to be able to produce significant tunability in the birefringence as well as the dispersion.

This application contrasts with that of the first embodiment. In the first embodiment the aim was to change the group velocity dispersion of the fibre without affecting modal properties significantly. Small dispersion tuning holes were used for this purpose. In the present embodiment, which has the aim of generating birefringence, the purpose of the dispersion tuning holes is to significantly change the modal properties of the fibre to provide a mode field that produces birefringence. In this case the dispersion tuning holes may be of a wide variety of sizes including large holes, as will be understood from the following.

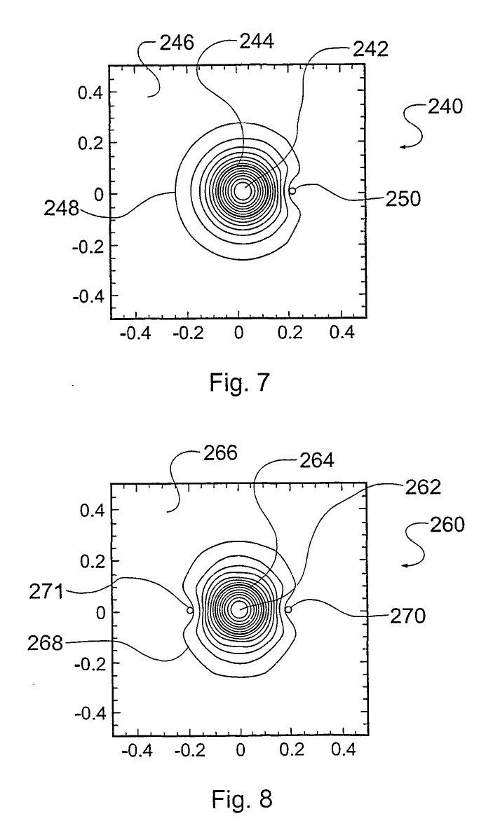

FIG. 7 shows in cross-section a schematic model of a novel step-index optical fibre structure 240. The fibre 240 comprises a core 242, a core boundary 244 and a cladding 246. These features are similar to, and will be understood from, the corresponding features shown in FIG. 5. However, in addition the fibre 240 contains a hole 250 which runs parallel to the guiding axis of the fibre 240. The hole 250 can, for example, be introduced into the fibre 240 prior to drawing, such as in the manner described above. In the exemplary fibre 240, the hole 250 has a diameter of 1 μm and its centre is 8.2 μm from the central axis of the fibre 240. Contours 248 which represent the fundamental guided mode of the fibre 240 at a wavelength of 1.55 μm are also shown in FIG. 7.

The asymmetry in the cross-section of the fibre 240 (in fact one-fold rotational symmetry) leads to a difference in the refractive index seen by mutually orthogonal polarisation states, and the fibre becomes birefringent. If the hole 250 were not present in the fibre 240, the fibre 240 would behave as a conventional step-index fibre, such as the fibre 200 shown in FIG. 5, and would not be birefringent.

The level of birefringence exhibited by a waveguide can be quantified by its characteristic beat length L_{B}. This is the distance over which the beam components which are aligned with the fast and slow axes of the waveguide develop a mutual phase difference of 2π. The higher the birefringence of a waveguide, the smaller the beat length. L_{B} is infinite for a non-birefringent fibre and typically around 0.01 m (10 mm) for a conventional birefringent fibre at wavelengths of around 1.55 μm. A conventional highly birefringent fibre might have a beat length which is as small as 0.0003 m (0.3 mm).

The beat length for the fundamental mode of the fibre 240 at a wavelength of 1.55 μm is calculated to be 0.17 m. The waveguide dispersion of the fibre 240 is calculated to be −5.1 ps/nm/km. Comparison of the contours 248 shown in FIG. 7 with those shown for the conventional step-index fibre 200 in FIG. 5 again suggests that the introduction of the hole 250 does not significantly alter the properties of the beam profile. Thus the introduction of the hole 250 provides a mechanism for altering the birefringent properties of the fibre, without significantly impacting some of its other properties.

Other low symmetry hole arrangements can lead to fibres with different levels of birefringence. For example, increasing the size, placement and/or shape of the hole 250 described above will allow a degree of tuning of the birefringence. Similarly, introducing additional holes will provide further ways of tuning the birefringence.

FIG. 8 shows in cross-section a schematic model of a novel step-index optical fibre structure 260. The model fibre 260 comprises a core 262, a core boundary 264 and a cladding 266. These features are similar to, and will be understood from, the corresponding features shown in FIG. 5. Additionally, the fibre 260 contains holes 270, 271 which run parallel to the guiding axis of the fibre 260. The holes 270, 271 can, for example, be introduced into the fibre 240 as described above. In the exemplary fibre 260, the holes 270,271 have a diameter of 1 μm, are directly opposed and their centres are at a distance of 8.2 μm from the central axis of the fibre 260. Contours 268 which represent the fundamental guided mode of the fibre 260 at a wavelength of 1.55 μm are also shown in FIG. 8.

The introduction of a second hole leads to a calculated beat length of 0.16 m, and waveguide dispersion of −4.1 ps/nm/km for the fundamental mode at a wavelength of 1.55 μm. The beat length is relatively unchanged from the fibre 240 containing only a single hole, but there is a larger change in the waveguide dispersion. The overall characteristic beam profile is again largely unaffected by the introduction of the holes.

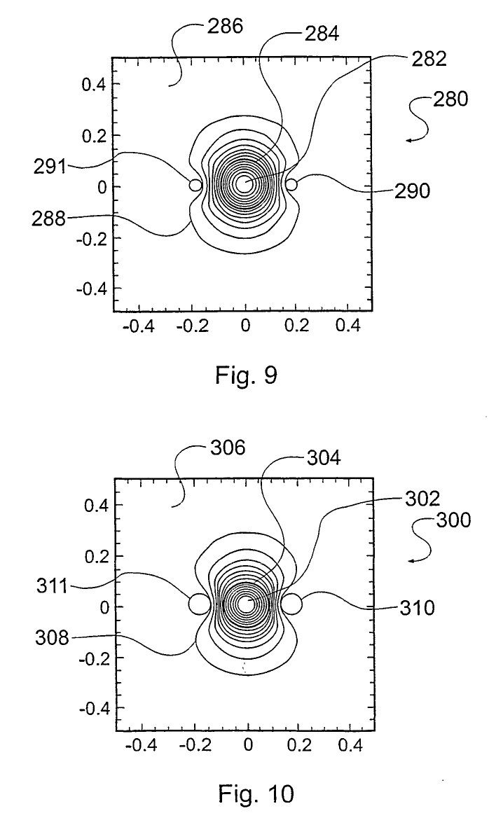

FIG. 9 shows in cross-section a schematic model of a novel step-index optical fibre structure 280. The model fibre 280 comprises a core 282, a core boundary 284, a cladding 286, and holes 290, 291. These features are similar to, and will be understood from, the corresponding features shown in FIG. 8. However, the holes 290, 291 in the fibre 280 are larger than those shown for the fibre 260 in FIG. 8. They are again directly opposed at a distance of 8.2 μm from the central axis of the fibre 280, but are 2 μm in diameter. Contours 288 which represent the fundamental guided mode of the fibre 280 at a wavelength of 1.55 μm are also shown in FIG. 9.

The introduction of larger holes leads to a calculated beat length of 0.1 m, and waveguide dispersion of −3.4 ps/nm/km for the fundamental mode at a wavelength of 1.55 μm.

FIG. 10 shows in cross-section a schematic model of a novel step-index optical fibre structure 300. The model fibre 300 comprises a core 302, a core boundary 304, a cladding 306, and holes 310, 311. These features are similar to, and will be understood from, the corresponding features shown in FIG. 8. However, the holes 310, 311 in the fibre 300 are larger still than those shown for the fibre 260 in FIG. 8. They are again directly opposed at a distance of 8.2 μm from the central axis of the fibre 280, but are 4 μm in diameter. Contours 308 which represent the fundamental guided mode of the fibre 300 at a wavelength of 1.55 μm are also shown in FIG. 10.

The introduction of larger holes leads to a calculated beat length of 0.05 m, and waveguide dispersion of −2.8 ps/nm/km for the fundamental mode at a wavelength of 1.55 μm.

The results described above show how the birefringence, and other optical properties, of otherwise conventional optical fibres can be modified by the introduction of an arrangement of longitudinal holes with two-fold or one-fold rotational symmetry. We have explicitly described four birefringent fibre structures, but clearly many more are available within the scope of the current invention. Modification of the shape, size, placement and/or number of holes, for example, allows fibre properties to be tailored such that they might better suit different applications requirements.

For holes which are rotationally symmetrically arranged around the central axis of the fibre (e.g. holes of the same size and shape spaced at equal angles and equal distances from the central axis of the fibre) there is no observed birefringence when there are three or more holes, that is with three-fold or higher order rotational symmetry. However, birefringent fibres can be made using more than two holes if they are not rotationally symmetrically disposed around the central fibre axis.

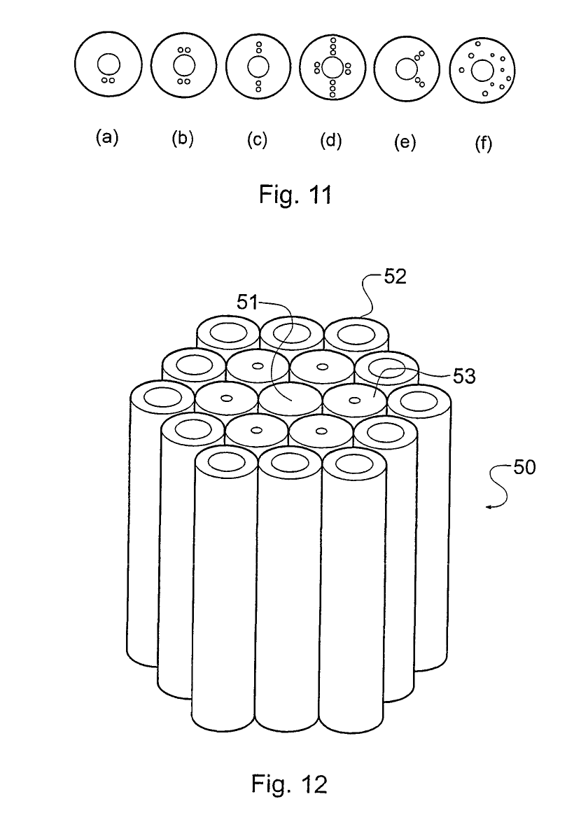

FIG. 11 schematically shows a small selection of hole distributions which might be used to provide birefringent fibres. There is essentially no limit to the number of possible different hole arrangements which might be used to provide fibres which exhibit different levels of birefringence.

It is appreciated that that the optical properties of these types of fibres could be modified further by filling or partially filling the voids comprising the holes with materials with refractive indices different to that of air, for example. It is also appreciated that similar tunability could be achieved by similarly modifying additional examples of otherwise conventional fibres, such as, for example, graded-index fibres. Furthermore, the birefringence of already birefringent fibres can also be modified by the introduction of tuning holes in a manner similar to that outlined above for conventional fibres.

Fibre Fabrication

Fibres such as those described above may be fabricated by several methods. One technique initially involves generating a fibre preform, from which the final fibre will be drawn. Two methods of preform fabrication are described in more detail below.

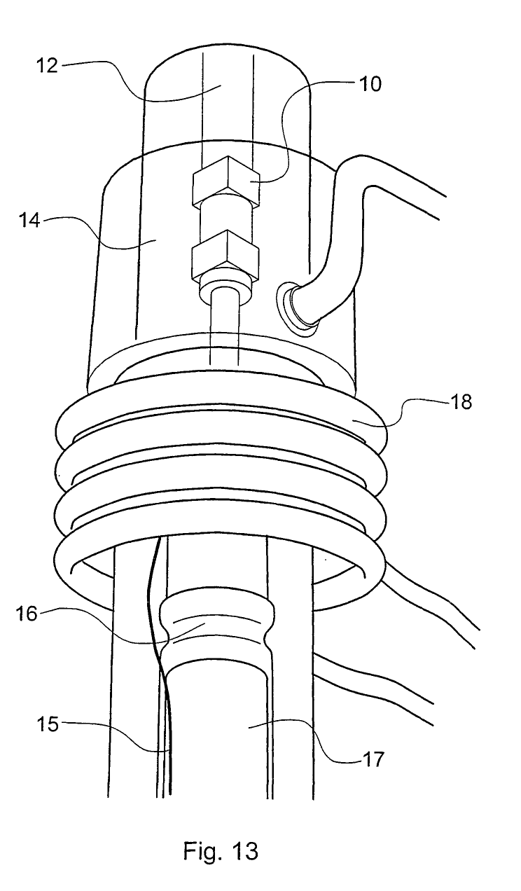

FIG. 12 schematically shows a preform 50 from which dispersion tailored fibres may be drawn. The preform 50 comprises a hexagonally close packed array of glass rods of equal outside diameter. The glass rods comprise a centre core rod 51, which is illustrated as being solid but may be tubular in alternative embodiments, surrounded by six further core rods 53, each of which has a small axial hole therein for forming substitutionally positioned dispersion tuning holes, surrounded in turn by a layer of cladding rods 52. Only one layer of cladding rods 52 is shown, but usually there will be several such layers, for example 2, 3 or 4. Moreover, the rods will be retained inside a larger tube (not shown). The cladding rods 52 are illustrated as being tubular, to form a holey-fibre cladding structure with larger inside diameter than the outer core rods 53. In other embodiments, the cladding rods 52 will be solid to provide a solid cladding, and thus a conventional fibre save for the additional dispersion tuning holes resulting from the rods 53.

The illustrated preform will thus provide a final fibre structure similar to that shown in FIG. 2. The preform can be drawn into fibre using conventional methods. Alternatively, a two-step drawing process may be employed in which the preform is first drawn into a cane of outside diameter of the same order of magnitude as a preform rod and then inserted into a second preform in which the cane occupies the position of the core rod in the first-stage preform. This second preform is then drawn into fibre.

Other methods of preform manufacture and assembly are also possible. For example, one alternative to the above preform fabrication method is to drill and mill the required preform profile out of a single solid piece of glass. Alternatively, rather than tubes, other geometries of internal structure could be employed.

For drawing, the preform is placed in a fibre drawing tower. Fibre drawing is performed by the controlled heating and/or cooling of the glass through a viscosity range of around 10⁶ poise. It is useful to monitor the diameter and tension of the fibre as it is being drawn and use the data thus acquired in an automatic feedback loop to control the preform feed speed, the fibre draw speed and/or other parameters related to the furnace in order to yield a uniform fibre diameter.

A principal component of the drawing tower used to pull the preform into fibre form is a heat source, which may be a graphite resistance heater or a radio-frequency (RF) furnace. The use of an RF source is preferred for the precise temperature control it provides. The role of the furnace is to heat the preform 50 prior to drawing into a fibre.

It is critical to control the fibre drawing temperature, and hence the glass viscosity, so that two criteria are met. First, the fibre drawing temperature must soften the glass to provide a viscosity for which the glass can deform and stretch into a fibre without crystallisation. Second, the softening of the glass must not be so great that the crucial internal structure, i.e. the holes, collapse and flow together.

FIG. 13 shows a furnace used to draw the fibres which satisfies these two criteria. The furnace incorporates an inductively heated (RF) hot zone defined by water-cooled helically wound RF coils 18. In use, the water cooled RF coils generate an RF field that heats a graphite susceptor (not visible). In the illustrated furnace, the RF coils define a 50 mm long hot zone around and along the preform.

A combination of water and gas cooling is provided above and below the hot zone. The cooling keeps the glass outside the hot zone cooled to below its crystallisation temperature. Elements of the cooling system are apparent from the figure, namely an upper gas halo 12, a lower gas halo 16, a cold finger 17, and a water jacket 14 made of silica. The upper gas halo and silica water jacket cool the preform prior to entry into the hot zone. The cold finger, and lower gas halo provide rapid cooling after the fibre emerges from the hot zone. A thermocouple 15 for monitoring furnace temperature is also indicated. The thermocouple forms part of a control system for regulating the furnace temperature.

A range of different coating materials can be used for coating the outside of the preform prior to or during drawing. Examples of coating materials are standard acrylates, resin, teflon, silicone rubber, epoxy or graphite. In particular, graphite coating can be used to good effect since it promotes stripping of cladding modes and also provides enhanced mechanical strength.

A second method of preform fabrication is a rod-in-tube (RIT) method. This may be used for the conventional-type fibre embodiments of the invention. Glass ingots (typical weight 170 g) are used to cut and polish rods and tubes measuring 10 mm in diameter by 100 mm in length. With a tube of outer diameter 10 mm, and internal diameter of 3.5 mm, a single collapse would give a core-clad ratio of 0.35. More collapses may be required to provide the required core diameter.

Based on the desired hole structure of the final fibre, corresponding longitudinal holes are placed in the rod and/or tube. These holes may be produced, for example, by extrusion, milling and drilling, polishing, piercing, spin/rotational casting, other casting methods (e.g. built-in casting), compression moulding or direct bonding etc.

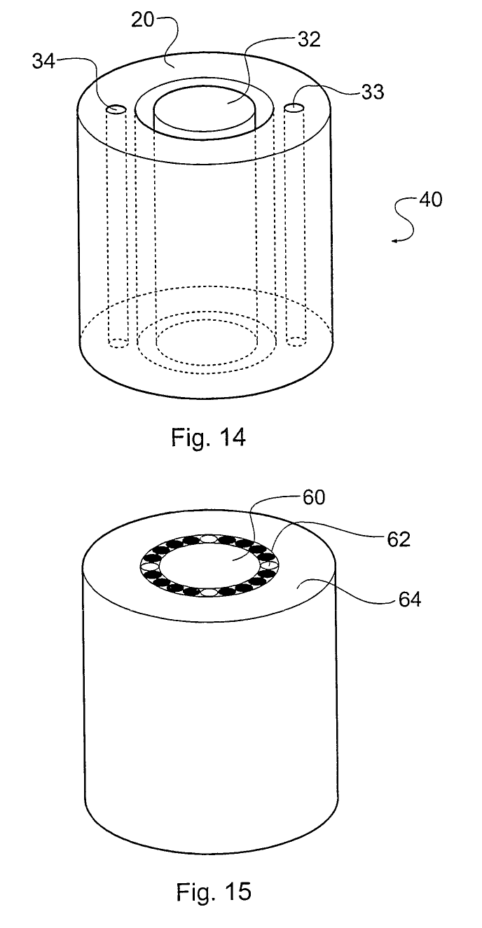

FIG. 14 is a schematic drawing of a dispersion tailored optical fibre rod-in-tube (RIT) preform. The preform 40 comprises a cladding tube 20 arranged around a core rod 32. The core rod 32 and cladding tube 20 will become the core and cladding of the completed fibre, and are made of any compatible materials. In this example, the cladding tube 20 has two longitudinal holes 33, 34, for example produced by drilling, so as to produce a birefringent fibre similar to that shown in FIG. 8. Instead of or in addition to providing one or more axial holes in the cladding tube, one or more axial holes could be provided in the core rod, towards its outer wall.

The rod in tube preform 40 can be attached to, and drawn from the a drawing tower in a manner which is similar to that described above for the packed array preform 50.

The same approach as described with reference to FIG. 14 could also be implemented with a powder-in-tube (PIT) technique, in which the core rod is replaced with powder.

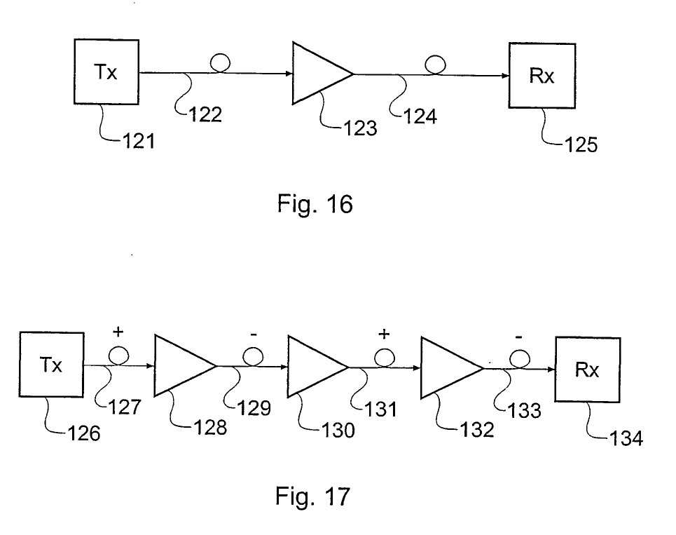

FIG. 15 shows a further preform type for producing conventional fibre with dispersion tuning holes. The preform comprising a cladding tube 64 made of the cladding glass inside of which is arranged a core rod 60 of the core glass. The core rod has an outside diameter less than the inner diameter of the cladding tube 64, the difference being large enough to allow a ring of smaller diameter rods 62 to fill the space between the core rod and cladding tube. All these smaller diameter rods may be tubular, or only a limited number of them, with the others being solid. In the illustration, solid rods 62 are shown with black ends, and tubular rods 62 with white ends, there being four symmetrically located tubular rods to provide an arrangement similar to that of FIG. 6. The smaller diameter rods may be made of the core glass or the cladding glass. Moreover, the structure shown in FIG. 16 may be modified further (not shown) by subdividing the central rod 60 into an inner core rod of the core glass, and an outer sleeve of the cladding glass. Drawing of these alternative preform types can be performed as described above.

Applications

FIG. 16 is a schematic representation of an optical signal communication system according to one application of one embodiment of the invention. A conventionally encoded optical signal is launched into an optical fibre 122 by a transmitting station 121, operating, for example, at 1.55 μm. A repeater station 123 receives the optical signal from the optical fibre 122 and amplifies it before transmitting it into a second length of optical fibre 124. A receiving station 125 receives the optical signal. The signal can subsequently be decoded. In this example, the sections of fibre 122, 124 are tuned according to the invention so as to provide substantially zero group velocity dispersion at the operating wavelength of 1.55 μm. This allows larger separation of repeaters than with conventional dispersive fibres. The lengths of the fibres 122, 124 are chosen to minimise the required number of repeaters, without introducing undue signal degradation due to fibre transmission losses. In this example, fibres 122, 124 are of length 100 km. It is also possible to change the sign of the group velocity dispersion of the fibre during drawing so that the fibre lengths 122, 124 may each be sections of fibre of alternating dispersion.

FIG. 17 is a schematic representation of an optical signal communication system according to one application of another embodiment of the invention. A conventionally encoded optical signal is launched into a conventional optical fibre 127 by a transmitting station 126, operating, for example, at 1.55 μm. A repeater station 128 receives the signal, amplifies it and transmits it into a section of fibre 129, which is tuned according to an embodiment of the invention to compensate for the dispersion of the conventional fibre 127. A further repeater 130 receives the signal from optical fibre 129 and retransmits it after amplification into a conventional optical fibre 131.

The signal is received by repeater 132 and transmitted after amplification into optical fibre 133, which is again a dispersion tuned fibre according to an embodiment of the invention, before being received by the receiving station 134 for decoding. The net effect of fibres of alternating positive and negative group velocity dispersion can be chosen to provide a link with zero overall group velocity dispersion.

This approach has the advantage that separate dispersion compensating elements can be eliminated from the repeaters. Specifically, the usual chirped fibre Bragg grating operating in reflection with an optical circulator can be dispensed with, thus reducing cost and complexity in the repeater, while increasing system reliability.

In this example the fibres 129, 133 according to the invention are tuned to provide a group velocity dispersion which is equal in magnitude but opposite in sign to that of the conventional fibres 127, 131. Accordingly, to provide substantially zero dispersion over the entire link, the integrated length of the inventive fibres 129, 133 is equal to the total length of the conventional fibres 127, 131. To span larger distances, more sections of alternating conventional and inventive fibres can be used with each being separated by additional repeaters. It is not necessary that the conventional and inventive fibres alternate. The fibres may also be arranged in any order, so long as the overall lengths of each are equal.

It is noted that the absolute magnitude of the group velocity dispersion in the compensating fibres may be more or less than in the conventional fibre. By appropriately selecting the overall lengths of conventional and compensative fibre, the link can still provide required overall zero group velocity dispersion.

Communication links can also be designed according to aspects of the invention so as to provide a non-zero overall group velocity dispersion. Such a link might be appropriate, for example, to allow for compensation of group velocity dispersion which arises elsewhere in a system.

Closing Remarks

In conclusion, it is clearly possible to obtain a degree of isolation of the mode size/shape from the dispersion which is two orders of magnitude better than in conventional fibres. However, there is currently no known way to reverse-engineer the dispersion properties of an optical fibre. Hence in order to predict which particular fibre profiles will allow this dispersion tuning, it is necessary to use a numerical technique which can accurately describe the complex fibre profile, as has been done here. Consequently, it is not clear at present how general this finding is, and it is unclear what range of holey fibre structures will allow this dispersion tuning. For example, it has been shown that holey fibres can be designed to have extremely flat dispersion [1], anomalous dispersion at short wavelengths [1] or for dispersion compensation [7]. We suggest that the dispersion in these classes of holey fibres could also be tuned using this technique.

### References

[1] T. M. Monro, D. J. Richardson, N. G. R. Broderick, and P. J. Bennett, “Holey optical fibres: an efficient modal model”, J. Lightwave Technol. 17, 1093-1102 (1999).

[2] J. C. Knight, T. A. Birks, P. St. J. Russell and D. M. Atkin, “All-silica single-mode optical fibre with photonic crystal cladding”, Opt. Lett. 21, 1547-1549 (1996).

[3] T. M. Monro, D. J. Richardson, N. G. R. Broderick and P. J. Bennett, “Modelling large air fraction holey optical fibres”, J. Lightwave Technol. 18, 50-57 (2000).

[4] N. G. R. Broderick, T. M. Monro, P. J. Bennett and D. J. Richardson, “Nonlinearity in holey optical fibres: measurement and future opportunities”, Opt Lett. 24, 1395-1397 (1999).

[5] P. J. Bennett, T. M. Monro and D. J. Richardson, “Towards practical holey fibre technology: Fabrication, Splicing, Modelling and Characterization”, Opt. Lett. 24, 1203-1205 (1999).

[6] Tanya M. Monro, P. J. Bennett, N. G. R. Broderick and D. J. Richardson, “Holey fibres with random cladding distributions”, Opt. Lett. 25, 206-208 (2000).

[7] T. A. Birks, D. Mogilevstev, J. C. Knight and P. St. J. Russell, “Dispersion compensation using single-material fibres”, IEEE Photonics Technology Lett. 11, 674-676 (1999).

[8] T. A. Birks, J. C. Knight and P. St. J. Russell, “Endlessly single-mode photonic crystal fibre”, Opt. Lett. 22, 961-963 (1997).

[9] J. Broeng, S. E. Sarkou, A. Bjarklev, “Polarization properties of photonic bandgap fibres”, paper ThG2, OFC 2000 Baltimore USA, 2000.

1. An optical fibre comprising a core and a cladding suitable for guiding light of a predetermined wavelength, further comprising one or more dispersion tuning holes each arranged laterally displaced from the geometrical axis of the optical fibre by a distance of at least one half the core radius.

2. An optical fibre according to claim 1, wherein the cladding is solid.

3. An optical fibre according to claim 1, wherein the cladding comprises refractive index tuning holes having cross-sectional widths greater than those of the dispersion tuning holes.

4. An optical fibre according to any one of the preceding claims, wherein the one or more dispersion tuning holes are arranged laterally displaced from the geometrical axis of the optical fibre by a distance of less than 2.5 times the core radius.

5. An optical fibre according to any one of claims 1 to 4, wherein the dispersion tuning holes are located interstitially with respect to a lattice defined by preform rods used to make the optical fibre.

6. An optical fibre according to any one of claims 1 to 4, wherein the dispersion tuning holes are located substitutionally with respect to a lattice defined by preform rods used to make the optical fibre.

7. An optical fibre according to any one of the preceding claims 1 to 6, wherein the dispersion tuning holes are sized and arranged to provide the optical fibre with group velocity dispersion of between ±5 ps/nm/km, more preferably ±4 ps/nm/km, still more preferably +2 ps/nm/km, or most preferably +4 ps/nm/km.

8. An optical fibre according to any one of the preceding claims 1 to 6, comprising first and second sections, wherein the dispersion tuning holes are sized and arranged differently in the first and second sections so as to provide the first and second sections of the optical fibre with respective group velocity dispersions of opposite sign.

9. An optical fibre according to any one of claims 1 to 8, wherein the one or more dispersion tuning holes comprises at least three holes arranged rotationally symmetrically about the geometrical axis of the optical fibre to allow tuning of the dispersion of the optical fibre without generating birefringence.

10. An optical fibre according to any one of claims 1 to 8, wherein the one or more dispersion tuning holes are arranged with two-fold or lower order rotational symmetry about the geometrical axis of the optical fibre to generate birefringence.

11. An optical fibre according to any one of the preceding claims, wherein the dispersion turning holes each have a cross-sectional width of less than approximately one-tenth or one-sixth of the predetermined wavelength, so as to allow tuning of the dispersion of the optical fibre while limiting changes in mode size.

12. An optical fibre transmission system comprising a transmitter, a receiver and an interconnecting optical fibre link, wherein the link comprises optical fibre according to any one of the preceding claims.

13. An optical fibre transmission system comprising a transmitter, a receiver and an interconnecting optical fibre link, wherein the link comprises serially concatenated sections of first and second optical fibre, wherein the first optical fibre is conventional optical fibre having a positive group velocity dispersion and the second optical fibre is optical fibre according to any one of claims 1 to 11 having a negative group velocity dispersion such that the link is substantially dispersionless.

14. An optical fibre preform comprising a plurality of rods packed together in an array, the rods comprising at least one centre core rod, surrounded by a plurality of tuning rods, at least one of which has an axial hole therein, surrounded in turn by at least one further layer of cladding rods which are solid.

15. An optical fibre preform comprising a plurality of rods packed together in an array, the rods comprising at least one centre core rod surrounded by a plurality of tuning rods, at least one of which has an axial hole therein, surrounded in turn by at least one further layer of cladding rods which have further axial holes therein, wherein the axial holes of the cladding rods are wider than the at least one axial hole of the tuning rods.

16. An optical fibre preform according to claim 14 or 15, wherein there is one solid centre core rod, and six tuning rods.

17. An optical fibre preform comprising a cladding tube of a cladding glass enclosing a core rod of a core glass, wherein the cladding tube and/or the core rod has at least one axial hole therein.

18. An optical fibre preform comprising a cladding tube of a cladding glass enclosing a powder of a core glass, wherein the cladding tube has at least one axial hole therein.

19. An optical fibre preform comprising a core rod of a core glass, a cladding tube of a cladding glass arranged outside the core rod, and a plurality of tuning rods, at least one of which has an axial hole therein, arranged between the cladding tube and the core rod.

20. A method of fabricating an optical fibre comprising:
providing an optical fibre preform according to any one of claims 14 to 19; and
drawing the preform into an optical fibre in which the axial holes in the tuning rods are retained with a cross-sectional width of between 0.05 and 0.2 micrometers.

21. A method of fabricating an optical fibre comprising:
providing an optical fibre preform comprising a plurality of rods packed together in an array, the rods comprising at least one solid centre rod surrounded by a plurality of outer rods, interstitial holes being formed between the centre and outer rods; and
drawing the preform into an optical fibre in which the interstitial holes are retained with a cross-sectional width of between 0.05 and 0.2 micrometers.

22. A method according to claim 21, wherein the outer rods are tubular to form a holey outer cladding in the optical fibre.

23. A method according to claim 21, wherein the outer rods are solid to form a solid surround for the interstitial holes in the optical fibre.

24. A method according to claim 21, 22 or 23, wherein there is one solid centre rod and six outer rods adjacent to the centre rod, thereby to form six interstitial holes.

25. An optical fibre comprising a core and a cladding, comprising one or more holes arranged laterally displaced from the geometrical axis of the optical fibre and arranged with a two-fold or lower degree of rotational symmetry about the geometrical axis of the optical fibre to generate birefringence.

26. An optical fibre according to claim 25, wherein the core and cladding are solid except for the one or more holes for generating birefringence.

27. An optical fibre according to claim 25, wherein the cladding is holey.

28. An optical fibre comprising a core and a cladding defining a mode field area for light of a predetermined wavelength to be guided by the optical fibre, the optical fibre further comprising at least three holes arranged laterally displaced from the geometrical axis of the optical fibre and arranged rotationally symmetrically about the geometrical axis of the optical fibre to allow tuning of the dispersion of the optical fibre without generating birefringence, wherein the core and cladding are solid over the mode field area except for the at least three holes for tuning the dispersion.
